(19) United States
(12) Patent Application Publication
(10) Pub. No.: US 2009/0153604 A1
(43) Pub. Date: Jun. 18, 2009

(54) Printing Device and Method Using The Same

(76) Inventors: Chao-Ming Chen, Taipei (TW); Wei-Sheng Lee, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 12/048,547

(22) Filed: Mar. 14, 2008

(30) Foreign Application Priority Data
Dec. 18, 2007 (TW) 096148364

(51) Int. Cl. B41J 29/38

(52) U.S. Cl. 347/9

(57) ABSTRACT

A printing device including a processor, a print-head, a carriage, a mask and a sensor is provided. The processor controls the operation of the printing device. The print-head fixedly configured in the printing device prints on an object. The carriage includes a fixing device for fixing the object. The carriage carries the object fixed thereon and moves relative to the print-head. The mask placed on the object has a hole for defining a printable area of the object. The sensor senses to obtain information including a position of the carriage and the printable area of the object. The information is provided for the print-head to print on the object within the printable area while the object is moved to below the print-head.

### BACKGROUND OF THE INVENTION

1. Field of the Invention

The present invention relates to a printing device, and more particularly to a manual printing device such as a nail printer.

2. Description of the Related Art

FIG. 1 is a three-dimensional diagram illustrating a prior art nail printer. Referring to FIG. 1, a nail printer 10 includes a finger fixing device 11, a display 12, a keyboard 13, an inkjet print-head 14 and rails 15 and 16. At first the user puts his fingers onto the finger fixing device 11, so that a camera (not shown) captures the images of the fingernails and these images are displayed on display 12. Various patterns are also displayed on display 12 and provided for the user to select by the keyboard 13. Finally, according to the pattern selected by the user, the inkjet print-head 14 is controlled to print the selected pattern on the fingernails, in which it is guided by the rail 15 to move in the direction of x-axis for one column inkjet printing, and guided by the rail 16 to move in the direction of y-axis for changing to next column as the paper feeding of the general printer.

If the nail printer 10 supports color printing which employs three-color (CMY) mixing, the inkjet print-head 14 includes a cyan inkjet print-head 141, a magenta inkjet print-head 142 and a yellow inkjet print-head 143 for providing cyan ink, magenta ink and yellow ink respectively. Because the inkjet print-head 14 moves in the direction of x-axis for one column inkjet printing, the cyan inkjet print-head 141, the magenta inkjet print-head 142 and the yellow inkjet print-head 143 must be aligned one by one in the direction of x-axis as shown in FIG. 1, so that the cyan ink, the magenta ink and the yellow ink can be jetted on the fingernails in sequence to mix various colors.

For the movement of the inkjet print-head 14, the nail printer 10 further includes a motor (not shown) for driving the inkjet print-head 14 to move in the direction of x-axis guided by the rail 15 or move in the direction of y-axis guided by the rail 16. Accordingly, the prior art nail printer 10 disburses cost to configure the motor and its specific driver, and needs space to contain the motor and the rails 15 and 16. Therefore, there is a need in the art for a nail printer that is simpler and cheaper.

### SUMMARY OF THE INVENTION

The present invention is directed to provide a printing device (such as a nail printer) which prints a pattern on an object without moving its print-head (such as an inkjet print-head), so that the printing device doesn't need to configure a motor and space for simplifying the printing device and reducing cost.

The present invention is further directed to provide a method for using the above-mentioned printing device which prints the pattern on the object without moving its print-head.

In accordance with the present invention, a printing device including a processor, a print-head, a carriage, a mask and a sensor is provided. The processor controls the operation of the printing device. The print-head fixedly configured in the printing device prints on an object. The carriage includes a fixing device for fixing the object. The carriage carries the object fixed thereon and moves relative to the print-head. The mask placed on the object has a hole for defining a printable area of the object. The sensor senses to obtain information including a position of the carriage and the printable area of the object. The information is provided for the print-head to print on the object within the printable area while the object is moved to below the print-head.

In accordance with the present invention, a method for using the above-mentioned printing device is provided. In the method, at first a pattern to be printed is selected. Next, the object is fixed on the carriage, and an adequate mask is selected to place on the object, in which the mask has a hole for defining an adequate printable area of the object. Next, the carriage is pulled out of the printing device by a user and moved to a start position, then the printing device is commanded to prepare to print, and then the carriage is pushed into the printing device by the user. Next, the information including the position of the carriage and the printable area of the object is obtained by the sensor, and accordingly the pattern is printed on the object within the printable area by the print-head when the printable area of the object is moved into a printing range of the print-head; and stopped printing when the printable area of the object is moved out of the printing range of the print-head. Finally, the carriage is pulled out of the printing device by the user to take the object from the carriage.

The present invention manually pushes the object to be printed through the fixedly configured print-head, senses the movement (or position) of the carriage carrying the object fixed thereon, and marks the printable area of the object by the mask. As a result, the printing device in accordance with the present invention doesn't need to configure a motor and space for driving the print-head to move, so that it simplifies the printing device and reduces cost.

### BRIEF DESCRIPTION OF THE DRAWINGS

The foregoing and other features of the disclosure will be apparent and easily understood from a further reading of the specification, claims and by reference to the accompanying drawings in which like reference numbers refer to like elements and wherein:

FIG. 1 is a three-dimensional diagram illustrating a conventional nail printer;

FIG. 2 is a block diagram illustrating a nail printer in accordance with one embodiment of the present invention;

FIG. 3 is a three-dimensional sketch diagram illustrating a nail printer in accordance with one embodiment of the present invention;

FIG. 4 is a diagram illustrating various masks used for a nail printer in accordance with one embodiment of the present invention;

FIGS. 5A-5C are top-view diagrams illustrating the position relationship of an inkjet print-head, a sensor and a carriage of a nail printer in accordance with one embodiment of the present invention respectively; and

FIG. 6 is a flowchart illustrating a method for using a nail printer in accordance with one embodiment of the present invention.

### DETAILED DESCRIPTION OF THE INVENTION

For convenience, in the embodiments thereinafter, the printing device is a nail printer for example and the print-head is an inkjet print-head for example.

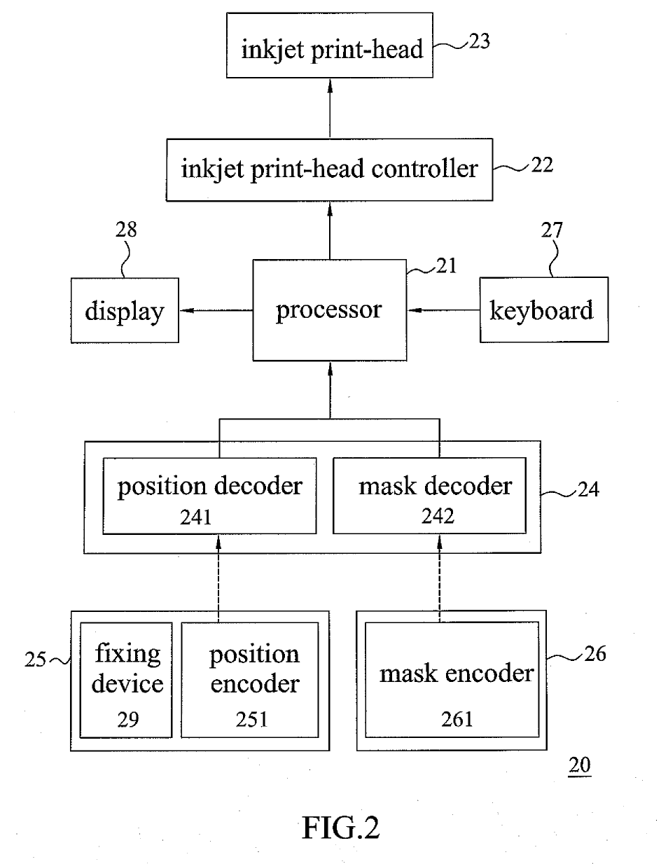

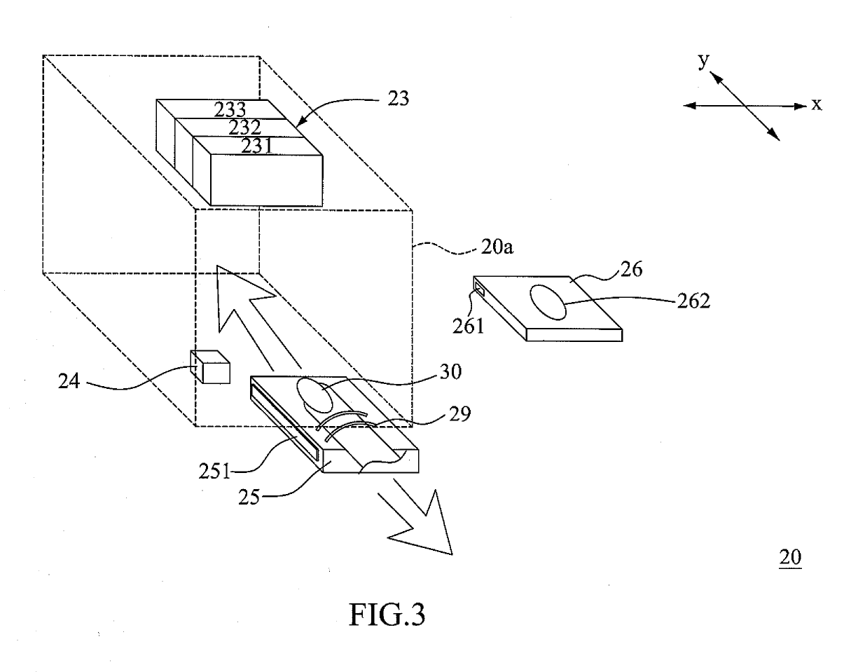

FIG. 2 is a block diagram illustrating a nail printer in accordance with one embodiment of the present invention. FIG. 3 is a three-dimensional sketch diagram illustrating some elements of the nail printer shown in FIG. 2. Referring to FIGS. 2 and 3, a nail printer 20 includes a processor 21, an inkjet print-head controller 22, an inkjet print-head 23, a sensor 24, a carriage 25, a mask 26, a keyboard 27 and a display 28. The carriage 25 further includes a fixing device 29 thereon. These elements may be contained in or configured on a case 20a of the nail printer 20. In one embodiment, the sensor 24 includes a position decoder 241, and relatively the carriage 25 includes a position encoder 251. Moreover, the sensor 24 further includes a mask decoder 242, and relatively the mask 26 further includes a mask encoder 261.

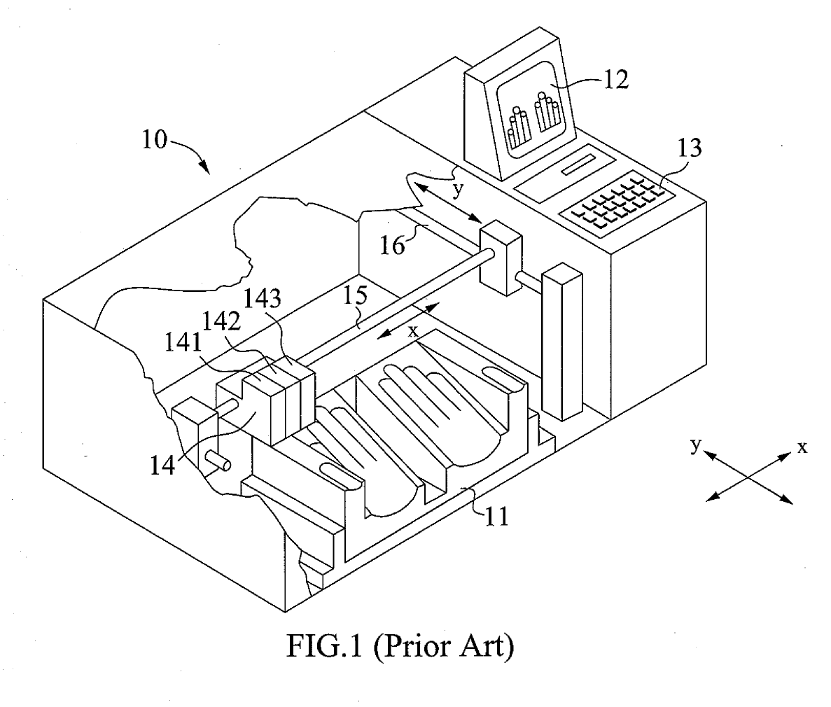

The processor 21 is electrically connected to the inkjet print-head controller 22, the sensor 24, the keyboard 27 and the display 28, and used for controlling the operation of the nail printer 20. The inkjet print-head controller 22 is electrically connected to the processor 21 and the inkjet print-head 23, and used for controlling the jet, the jetted velocity and the jetted range of ink of the inkjet print-head 23 according to the command of the processor 21. The inkjet print-head 23 is fixedly configured in the nail printer 20 and above the carriage 25, and used for printing on an object 30 to be printed. The object 30 may be a human nail or an artificial nail. In the embodiment, the object 30 is a human fingernail. The inkjet print-head 23 in accordance with the invention is fixedly configured, unlike the prior art inkjet print-head 14 as shown in FIG. 1 moving along the rails 15 and 16. Therefore, the invention doesn't need to configure a motor and space for driving the inkjet print-head 14 to move, so that it simplifies the nail printer 20 and reduces cost. It is noticed that the printing range of the inkjet print-head 23 must be designated to cover the width of the object 30 (i.e. the length of the object 30 in the direction of x-axis).

The carriage 25 is a drawer-like movable device below the inkjet print-head 23, and moves relative to the inkjet print-head 23 in the direction of y-axis as shown in FIG. 3. In addition, because the carriage 25 includes the fixing device 29 for fixing the object 30 on the carriage 25, the movement of the carriage 25 corresponds to the movement of the object 30. For example, the carriage 25 can be pulled out of the case 20a in the direction y-axis, so that it is convenient for the user to put and fix the object 30 on the carriage 25; or, the carriage 25 can be pulled into the case 20a in the direction y-axis, so that the object 30 fixed on the carriage 25 can be moved below the inkjet print-head 23 for printing.

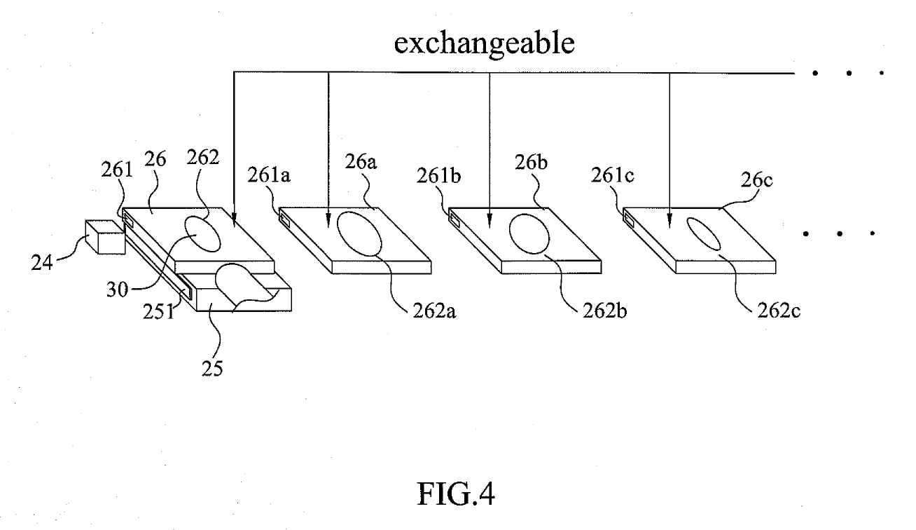

The mask 26 is used for placing on the object 30, in which the object 30 is sandwiched in between the mask 26 and the carriage 25, as shown in FIG. 4. The mask 26 has a hole 262 for defining the printable area of the object 30. Generally speaking, the nail printer 20 in accordance with the present invention provides multiple masks as shown in FIG. 4. The masks 26a, 26b, 26c, . . . have the holes 262a, 262b, 262c, . . . respectively. Various size of holes 262a, 262b, 262c, . . . define various size of printable areas. The user can select an adequate mask to place on the object 30.

The sensor 24 is electrically connected to the processor 21, and used for sensing to obtain the information including the position of the carriage 25 and the printable area of the object 30. It is understood that the position of the carriage 25 corresponds to the position of the object 30 fixed on the carriage 25. According to the information sensed by the sensor 24, the processor 21 sends commands to the inkjet print-head controller 22 for controlling the inkjet print-head 23 to print on the printable area of the object 30 when the object 30 is moved to below the inkjet print-head 23.

In the embodiment, the carriage 25 includes the position encoder 251, and relatively the sensor 24 includes the position decoder 241. The position encoder 251 cooperates with the position decoder 241 to perform that the sensor 24 obtains the information about the position of the carriage 25. The position encoder 251 moves with the movable carriage 25, but the position decoder 241 is fixedly configured. For example, the position encoder 251 is an encoding strip, which divides a strip into several parts and marks a code (such as a Gray code) for each part for representing a linear displacement. Therefore, the position encoder 251 provides a code corresponding to the position of the carriage 25, and then the code is sensed form the position encoder 251 by the sensor 24. Next, the code is decoded by the position decoder 241, and then the decoded information about the position of the carriage 25 is transmitted to the processor 21.

In the embodiment, the mask 26 includes the mask encoder 261, and relatively the sensor 24 includes the mask decoder 242. The mask encoder 261 cooperates with the mask decoder 242 to perform that the sensor 24 obtains the information about the printable area of the object 30. For example, the mask encoder 261 is a one-dimensional or two-dimensional barcode, which stores data in a specific encoding. The data stored in the barcode may be the data used for identification or the data about the printable area for the inkjet print-head 23. As shown in FIG. 4, the masks 26a, 26b, 26c, . . . have the mask encoders 261a, 261b, 261c, . . . respectively. Therefore, the mask encoder 261 provides a code corresponding to the printable area of the object 30 provided by the mask 26, and then the code is sensed form the mask encoder 261 by the sensor 24. Next, the code is decoded by the mask decoder 242, and then the decoded information about the printable area of the object 30 is transmitted to the processor 21.

In addition, if the nail printer 20 supports color printing, the inkjet print-head 23 includes multiple color inkjet print-heads. For example, in the embodiment, the inkjet print-head 23 includes a cyan inkjet print-head 231, a magenta inkjet print-head 232 and a yellow inkjet print-head 233 for providing cyan ink, magenta ink and yellow ink respectively. Because the inkjet print-head 23 is fixedly configured and the object 30 is movable in the direction of y-axis for performing one column inkjet printing, the cyan inkjet print-head 141, the magenta inkjet print-head 142 and the yellow inkjet print-head 143 must be aligned one by one in the direction of y-axis (i.e. the direction of the object 30 or carriage 25 moving) as shown in FIG. 3, so that the cyan ink, the magenta ink and the yellow ink can be jetted on the object 30 in sequence to mix various colors.

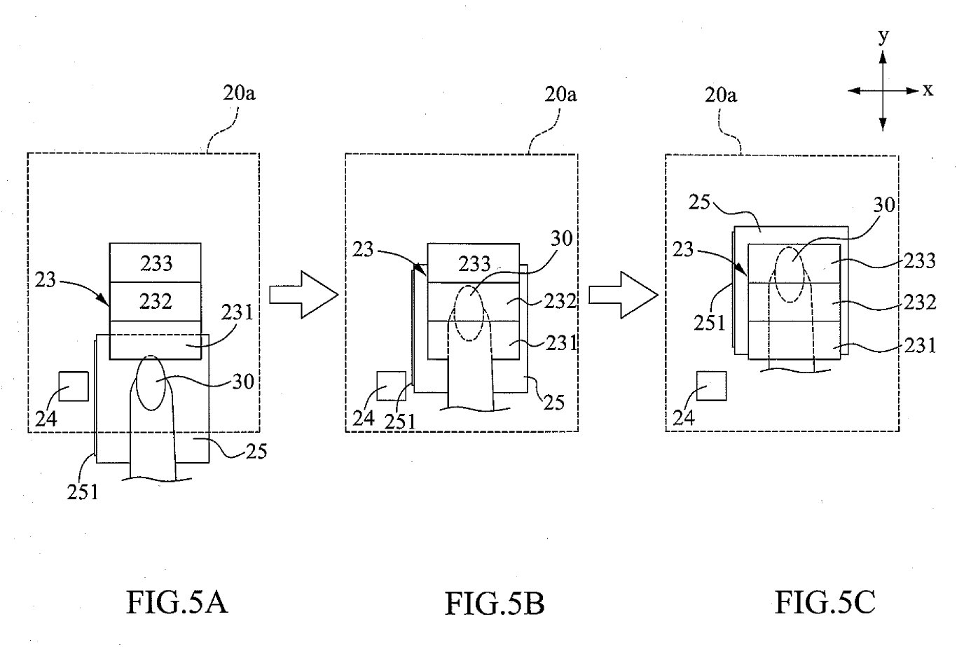

FIGS. 5A-5C are top-view diagrams illustrating the position relationship of the inkjet print-head 23, the sensor 24 and the carriage 25 of the nail printer 20 shown in FIG. 3 respectively. Referring now to FIGS. 5A-5C, the object 30 moves with the movable carriage 25, so that the position of the carriage 25 sensed by the sensor 24 corresponds to the position of the object 30 sensed by the sensor 2. At first, as shown in FIG. 5A, when the sensor 24 senses that the object 30 is moved to below the cyan inkjet print-head 231 and within its printing range, the cyan inkjet print-head 231 jets the cyan ink onto the object 30. Next, as shown in FIG. 5B, when the sensor 24 senses that the object 30 is moved to below the magenta inkjet print-head 232 and within its printing range, the magenta inkjet print-head 232 jets the magenta ink onto the object 30, in which now it is two-color (cyan and magenta) mixing. Next, as shown in FIG. 5C, when the sensor 24 senses that the object 30 is moved to below the yellow inkjet print-head 233 and within its printing range, the yellow inkjet print-head 233 jets the yellow ink onto the object 30, in which now it is three-color (cyan, magenta and yellow) mixing. Finally, after the entire object 30 is moved through the inkjet print-heads 231-233, the work of printing the color pattern on the object 30 is performed.

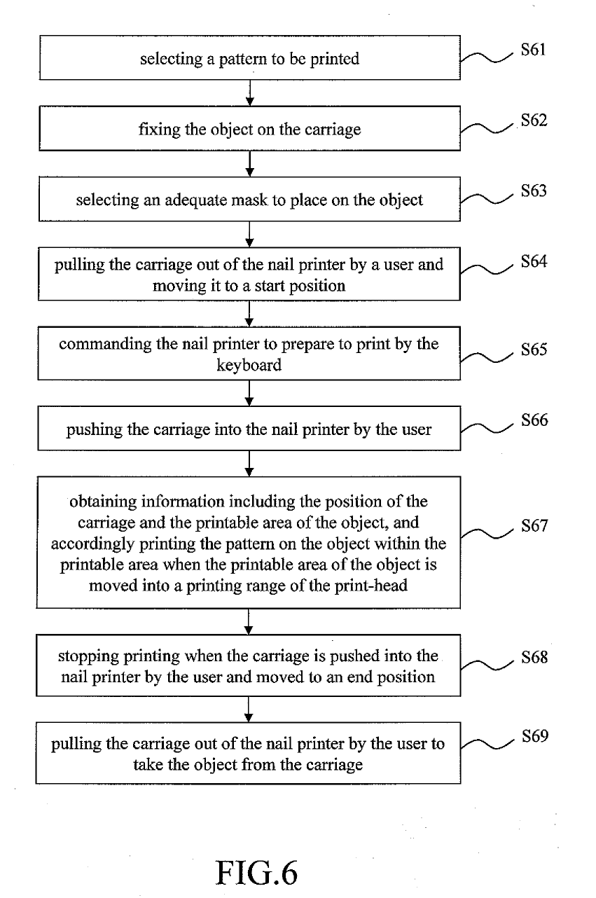

FIG. 6 is a flowchart illustrating a method for using the nail printer shown in FIG. 3 (or FIG. 2). Referring now to FIGS. 2, 3 and 6, at the step S61, the user selects the pattern to be printed by the keyboard 27 and the display 28, and determines the size of the pattern and the position where the pattern will be printed on the object 30 (such as a human fingernail). At the step S62, the user puts the object 30 on the carriage 25 and fixes it by the fixing device 26. At the step S63, according to the size of the object 30, the user selects the adequate mask 26 and places it on the object 30. At the step S64, the user pulls the carriage 25 out of the case 20a of the nail printer 20 and moves it to the start position, in which the position of the start position must satisfy that the object 30 is not below the inkjet print-head 23 and not within its printing range. At the step S65, the user presses the start button of the keyboard 27 to command the nail printer 20 to prepare to print, and then at the step S66, the user pushes the carriage 25 into the case 20a.

After the nail printer 20 is commanded to prepare to print, the sensor 24 ceaselessly senses to obtain the information including the position of the carriage 25 and the printable area of the object 30. Because the carriage 25 is pulled or pushed by the user, the moving speed of the carriage 25 is not a constant, so that the sensor 24 must ceaselessly sense the information about the position of the carriage 25. However, when the information about the printable area of the object 30 is sensed and obtained by the sensor 24, the information about the printable area of the object 30 is no longer sensed and obtained again while performing the entire printing. At the step S67, when the printable area of the object 30 is within the printing range of the inkjet print-head 23, according to the above-obtained information, the above-selected pattern and above-determined size and position of the pattern, the inkjet print-head 23 is controlled to print within the printable area of the object 30. At the step S68, when the user pushes the carriage 25 into the case 20a and moves it to the end position, the nail printer 20 is stopped printing. At the step S69, the user pulls the carriage 25 out of the case 20a, and takes the printed object 30 from the carriage 25.

In summary, the present invention manually pushes the object to be printed through the fixedly configured print-head, senses the movement (or position) of the carriage carrying the object fixed thereon, and marks the printable area of the object by the mask. As a result, the printing device in accordance with the present invention doesn't need to configure a motor and space for driving the print-head to move, so that it simplifies the printing device and reduces cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A printing device, comprising:
a processor for controlling the operation of the printing device;
a print-head, fixedly configured in the printing device, for printing on an object;
a carriage, including a fixing device for fixing the object, for carrying the object fixed thereon and moving relative to the fixed print-head;
a mask, placed on the object, having a hole for defining a printable area of the object; and
a sensor for sensing to obtain information including a position of the carriage and the printable area of the object, wherein the information is provided for the print-head to print on the object within the printable area while the object is moved to below the print-head.

2. The printing device as recited in claim 1, wherein the carriage includes a position encoder for providing a code corresponding to the position of the carriage, and the sensor includes a position decoder for decoding the code sensed from the position encoder by the sensor and obtaining the information about the position of the carriage.

3. The printing device as recited in claim 1, wherein the mask includes a mask encoder for providing a code corresponding to the printable area of the object, and the sensor includes a mask decoder for decoding the code sensed from the mask encoder by the sensor and obtaining the information about the printable area of the object.

4. The printing device as recited in claim 1, wherein the print-head includes a plurality of color print-heads aligned one by one in the direction of the carriage moving.

5. The printing device as recited in claim 1, wherein the printing device is a nail printer.

6. The printing device as recited in claim 5, wherein the object is a human nail or an artificial nail.

7. A method for using the printing device as recited in claim 1, comprising:
selecting a pattern to be printed;
fixing the object on the carriage;
selecting an adequate mask to place on the object, wherein the mask has a hole for defining an adequate printable area of the object;
pulling the carriage out of the printing device by a user and moving it to a start position;
commanding the printing device to prepare to print;
pushing the carriage into the printing device by the user;
obtaining the information including the position of the carriage and the printable area of the object by the sensor, and accordingly printing the pattern on the object within the printable area of the object by the print-head when the printable area of the object is moved into a printing range of the print-head; and stop printing when the printable area of the object is moved out of the printing range of the print-head; and
pulling the carriage out of the printing device by the user to take the object from the carriage.

8. A method for using the printing device as recited in claim 1, comprising:
selecting a pattern to be printed;
fixing the object on the carriage;
selecting an adequate mask to place on the object, wherein the mask has a hole for defining an adequate printable area of the object;
pulling the carriage out of the printing device by a user and moving it to a start position;
commanding the printing device to prepare to print;
pushing the carriage into the printing device by the user;
obtaining the information including the position of the carriage and the printable area of the object by the sensor, and accordingly printing the pattern on the object within the printable area of the object by the print-head when the printable area of the object is moved into a printing range of the print-head; and stop printing when the carriage is pushed into the printing device by the user and moved to an end position; and
pulling the carriage out of the printing device by the user to take the object from the carriage.
